(19) United States
(12) Patent Application Publication
(10) Pub. No.: US 2026/0120022 A1
(43) Pub. Date: Apr. 30, 2026

(54) GROUPING APPARATUS, GROUPING METHOD AND PROGRAM

(71) Applicant: NTT, Inc., Tokyo (JP)

(72) Inventors: Yusuke NAKANO, Tokyo (JP); Zhao WANG, Tokyo (JP)

(21) Appl. No.: 19/117,801

(22) PCT Filed: Oct. 28, 2022
(86) PCT No.: PCT/JP2022/040355

§ 371 Date: Apr. 2, 2025

(51) Int. Cl. G06Q 10/0631

(52) U.S. Cl. CPC G06Q 10/06316

(57) ABSTRACT

A grouping device according to an aspect of the present disclosure is a grouping device that groups targets in work directions when predetermined work is performed and includes a grouping unit that groups the targets on which the work is performed at one time into an identical group by an entity performing the work based on the work direction of the targets.

### TECHNICAL FIELD

The present disclosure relates to a grouping device, a grouping method, and a program.

### BACKGROUND ART

In the related art, in order to inspect utility poles, cyclic routes indicating efficient visiting orders therefor have been generated. In the generation of such cyclic routes, reinforced learning is often used. On the other hand, when the number of utility poles is large in reinforced learning, there is a problem that the memory consumption becomes high and learning cannot be performed or a precise cyclic route cannot be generated even if learning can be performed.

In order to solve the above problem, it is conceivable that a cyclic route be generated by setting each of groups as a visiting destination after the utility poles are grouped. Here, as a grouping method of grouping some targets, a clustering method represented by a k-means method is known (for example, Non Patent Literature 1). In addition to the k-means method, there are various methods such as hierarchical clustering as clustering methods. Here, when the utility poles are inspected, the utility poles along roads are generally inspected in a traveling direction of a vehicle by an inspection work vehicle moving straight along the roads. Therefore, it is necessary to group the utility poles along the same road that are inspected in the traveling direction (that is, the utility poles that are inspected at one time in work) as the same group.

### CITATION LIST

### Non Patent Literature

Non Patent Literature: Ishii, Kenichiro, Ueda Naonori, “Pattern Recognition Easy To Understand—Introduction to Unsupervised Learning—”, Ohmsha (2014/8/26)

### SUMMARY OF INVENTION

### Technical Problem

However, in the grouping method of the related art, utility poles are grouped simply by geographical closeness or the like without considering a traveling direction during inspection of the utility poles. Therefore, when the utility poles are grouped by a grouping method of the related art, the utility poles may be grouped unsuitably in inspection of the utility poles. This is not limited to utility poles that have a traveling direction during inspection, and the same applies to a case in which targets have a direction for some work or the like (for example, guard rails, manholes, and traffic lights that have a traveling direction during inspection similarly to utility poles) are grouped.

The present disclosure has been devised in view of the foregoing circumstances and an object of the present disclosure is to provide a technique for grouping targets in consideration of directions of the targets.

### Solution to Problem

According to an aspect of the present disclosure, a grouping device groups targets in work directions when predetermined work is performed and includes a grouping unit that groups the targets on which the work is performed at one time into an identical group by an entity performing the work based on the work direction of the targets.

### Advantageous Effects of Invention

A technique for grouping targets in consideration of directions of the targets is provided.

### BRIEF DESCRIPTION OF DRAWINGS

FIG. 1 is a diagram illustrating an example of a hardware configuration of a grouping device according to a first embodiment.

FIG. 2 is a diagram illustrating an example of a functional configuration of the grouping device according to the first embodiment.

FIG. 3 is a diagram illustrating an example of utility pole data.

FIG. 4 is a flowchart illustrating an example of grouping processing according to the first embodiment.

FIG. 5 is a diagram (Part 1) illustrating an example of the grouping according to the first embodiment.

FIG. 6 is a diagram (Part 2) illustrating an example of the grouping according to the first embodiment.

FIG. 7 is a diagram (Part 3) illustrating an example of the grouping according to the first embodiment.

FIG. 8 is a diagram (Part 4) illustrating an example of the grouping according to the first embodiment.

FIG. 9 is a flowchart (Part 1) illustrating an example of group integration processing according to the first embodiment.

FIG. 10 is a flowchart (Part 2) illustrating an example of group integration processing according to the first embodiment.

FIG. 11 is a diagram illustrating an example of a functional configuration of a grouping device according to a second embodiment.

FIG. 12 is a flowchart illustrating an example of grouping processing according to the second embodiment.

FIG. 13 is a diagram (Part 1) illustrating an example of the grouping according to the second embodiment.

FIG. 14 is a diagram (Part 2) illustrating an example of the grouping according to the second embodiment.

FIG. 15 is a diagram (Part 3) illustrating an example of the grouping according to the second embodiment.

### DESCRIPTION OF EMBODIMENTS

Hereinafter, embodiments of the present invention will be described. In each of the following embodiments, a grouping device 10 capable of grouping targets in directions for some work or the like in consideration of the directions of the targets will be described.

Here, a case will be described in which utility poles in a traveling direction during inspection are set as targets and the utility poles along the same road to be inspected in the traveling direction (that is, utility poles to be inspected at one time in work by an inspection work vehicle) are grouped into the same group.

Here, setting the utility poles in the traveling direction during inspection as grouping targets is exemplary, and the grouping targets are not limited thereto. Each of the embodiments to be described below can be applied similarly when any targets in directions for some work or the like are grouped. For example, the present invention can be applied similarly when guardrails, manholes, traffic lights, and the like in a traveling direction during inspection are grouped.

### First Embodiment

Hereinafter, a first embodiment will be described below.

### <Example of Hardware Configuration of Grouping Device 10>

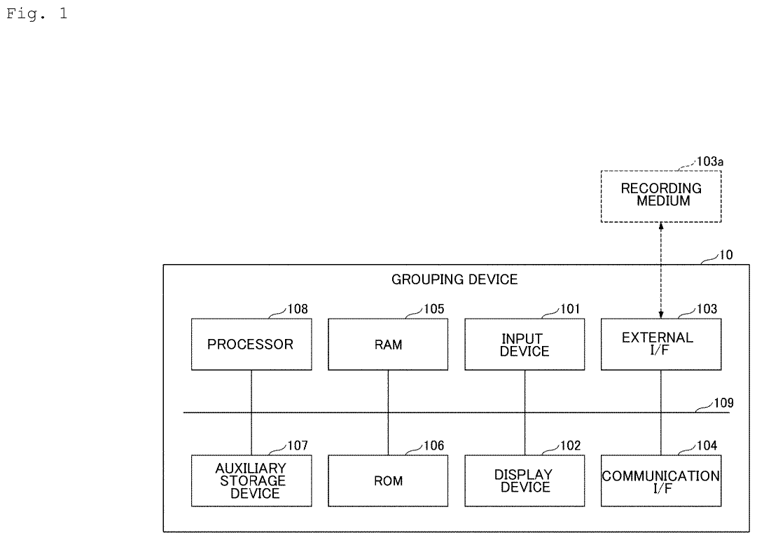

FIG. 1 illustrates an example of a hardware configuration of a grouping device 10 according to the present embodiment. As illustrated in FIG. 1, the grouping device 10 according to the present embodiment includes an input device 101, a display device 102, an external I/F 103, a communication I/F 104, a random access memory (RAM) 105, and a read only memory (ROM) 106, an auxiliary storage device 107, and a processor 108. Each piece of hardware is connected to be able to communicate via a bus 109.

The input device 101 is, for example, a keyboard, mouse, touchscreen, or physical buttons. The display device 102 is, for example, a display or display panel. The grouping device 10 may not include, for example, at least one of the input device 101 and the display device 102.

The external I/F 103 is an interface with an external device such as a recording medium 103a. The grouping device 10 can perform reading and writing from and on the recording medium 103a via the external I/F 103. Examples of the recording medium 103a include a flexible disk, a compact disc (CD), a digital versatile disk (DVD), a secure digital (SD) memory card, and a universal serial bus (USB) memory card.

The communication I/F 104 is an interface connecting the grouping device 10 to a communication network. The RAM 105 is a volatile semiconductor memory (storage device) that temporarily retains a program and data. The ROM 106 is a nonvolatile semiconductor memory (storage device) which can retain a program and data even when the power is turned off. The auxiliary storage device 107 is, for example, a storage device such as a hard disk drive (HDD), a solid state drive (SSD), or a flash memory. The processor 108 is, for example, an arithmetic device such as a central processing unit (CPU) or a graphics processing unit (GPU).

The grouping device 10 according to the present embodiment that has the hardware configuration illustrated in FIG. 1 can realize various types of processing to be described below. The hardware configuration illustrated in FIG. 1 is merely exemplary, and the hardware configuration of the grouping device 10 is not limited thereto. For example, the grouping device 10 may include a plurality of auxiliary storage devices 107 or a plurality of processors 108, may not have part of the hardware illustrated in the drawing, or may have various types of hardware other than the hardware illustrated in the drawing.

### <Functional Configuration Example of Grouping Device 10>

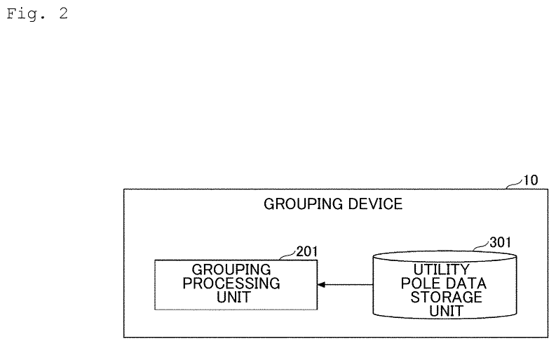

FIG. 2 illustrates an example of a functional configuration of the grouping device 10 according to the present embodiment. As illustrated in FIG. 2, the grouping device 10 according to the present embodiment includes a grouping processing unit 201. The grouping processing unit 201 is realized through, for example, processing in which one or more programs installed on the grouping device 10 cause the processor 108 to execute processing. The grouping device 10 according to the present embodiment includes a utility pole data storage unit 301. A utility pole data storage unit 301 is realized by, for example, the auxiliary storage device 107. Here, the utility pole data storage unit 301 may be realized by, for example, a storage device such as a database server or the like connected to the grouping device 10 via a communication network.

A grouping processing unit 201 groups utility pole data indicating utility poles in a traveling direction during inspection into the same group in which there are utility poles along the same road inspected in the traveling direction. The grouping processing unit 201 integrates a group in which the number of utility poles is one or a group in which the number of utility poles is small into other groups as a result of the grouping.

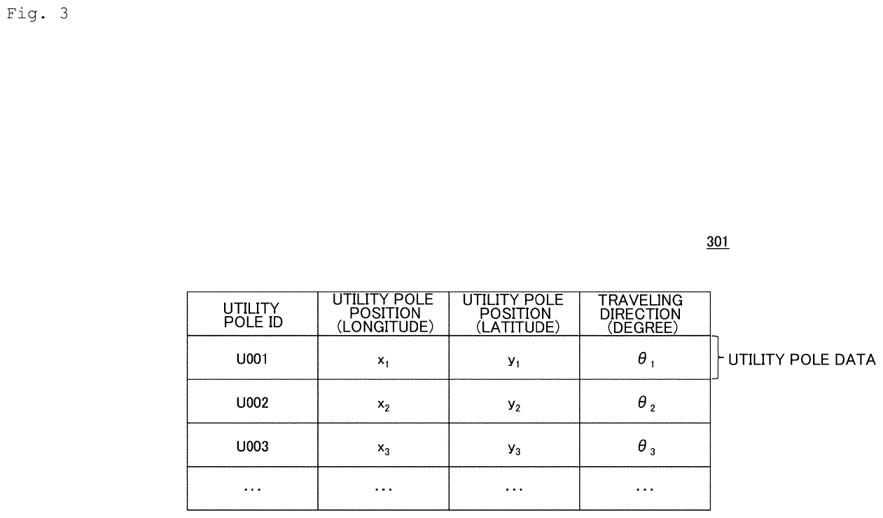

The utility pole data storage unit 301 stores utility pole data indicating grouping target utility poles. Here, FIG. 3 illustrates an example of the utility pole data stored in the utility pole data storage unit 301. As illustrated in FIG. 3, the utility pole data includes a “utility pole ID”, a “utility pole position (longitude)”, a “utility pole position (latitude)”, and “traveling direction (degree)” as attributes. For the “utility pole ID”, a utility pole ID which is identification information for uniquely identifying utility pole data is set. For the “utility pole position (longitude)”, a position (a value of x coordinate) of the utility pole in a longitudinal direction of a utility pole is set. The position of the pole in the latitude direction (the value of y coordinate) is set in the “pole position (latitude)”. For the “traveling direction (degree)”, an angle indicating a traveling direction during inspection of utility poles is set. For the angle, a counterclockwise (or clockwise) direction with respect to a predetermined reference line (for example, an x axis on an xy plane) is expressed as a positive direction. Hereinafter, it is assumed that a utility pole is disposed on the xy plane and a counterclockwise direction of the traveling direction is expressed as a positive direction with respect to the x axis.

In the example illustrated in FIG. 3, the following three pieces of utility pole data are illustrated.

(“utility pole ID”=0001, “utility pole position (longitude)”=x₁, “utility pole position (latitude)”=y₁, “traveling direction (degree)”=θ₁) (“utility pole ID”=0002, “utility pole position (longitude)”=x₂, “utility pole position (latitude)”=y₂, “traveling direction (degree)”=θ₂) (“utility pole ID”=0003, “utility pole position (longitude)”=x₃, “utility pole position (latitude)”=y₃, “traveling direction (degree)”=θ₃) The utility pole data illustrated in FIG. 3 is exemplary, and the utility pole data may have various attributes other than the foregoing attributes. For example, the utility pole data may have attributes such as installation dates of utility poles, names of prefectures and names of cities, towns, and villages where the utility poles are installed, kinds of the utility poles (for power transmission, communication, sharing, or the like).

### <Grouping Processing>

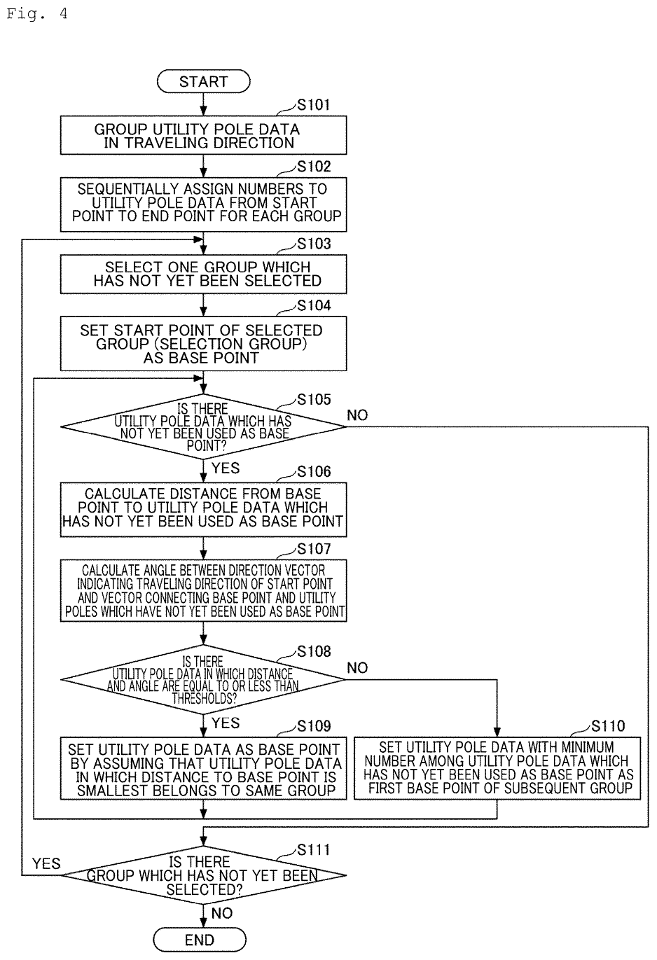

Grouping processing according to the present embodiment will be described with reference to FIG. 4.

First, the grouping processing unit 201 groups the utility pole data stored in the utility pole data storage unit 301 in the traveling direction (step S101). For example, the grouping processing unit 201 sets the utility pole data in which a traveling direction is (n-1) Δ≤θ<n (where, n=1, . . . , N) as Δ=2π/N (where N is an integer of 1 or more determined in advance) as an n-th group.

Accordingly, the utility pole data are grouped into N groups (including a group having the number of elements of 0). Specifically, for example, when Δ=30°, the utility pole data is grouped into twelve groups.

The utility pole data are grouped in the traveling direction in step S101, but the present invention is not limited thereto. For example, the utility pole data may be grouped by a known clustering method (for example, a k-means method or hierarchical clustering).

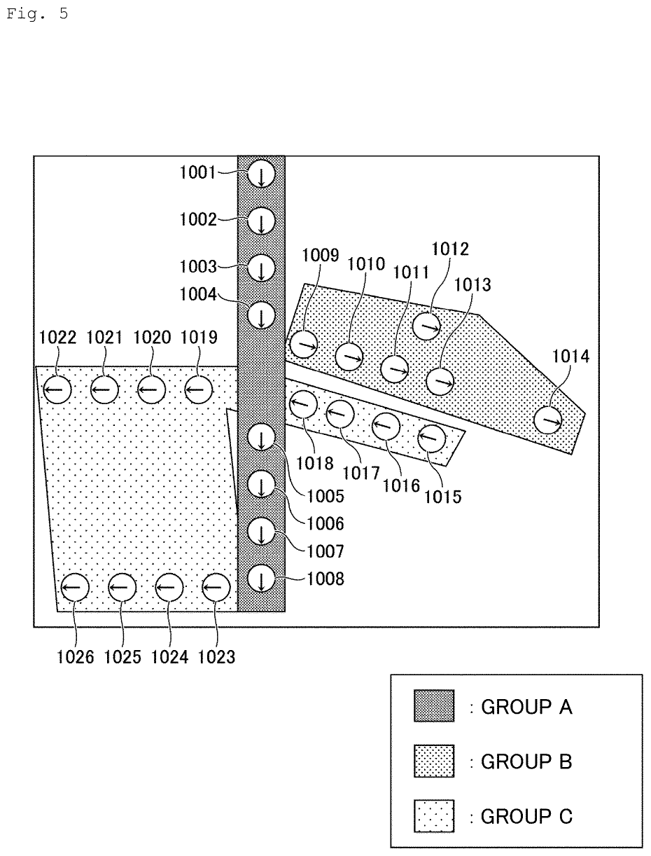

Hereinafter, a case where the utility pole data indicating utility poles 1001 to 1026 are grouped into groups A to C, as illustrated in FIG. 5, will be described as an example. In the example illustrated in FIG. 5, utility pole data indicating utility poles 1001 to 1008 are grouped into group A, utility pole data indicating utility poles 1009 to 1014 are grouped into group B, and utility pole data indicating utility poles 1015 to 1026 are grouped into a group C. In the example illustrated in FIG. 5, arrows in the circles indicating the utility poles 1001 to 1026 each indicate the traveling direction of the utility poles.

Subsequently, the grouping processing unit 201 sequentially assigns numbers to the utility pole data from the start point to the end point for each group grouped in the foregoing step S101 (step S102). That is, the grouping processing unit 201 sequentially assigns numbers to the utility pole data from the start point to the end point by setting the start point as the first in the same group. At this time, the grouping processing unit 201 defines each piece of utility pole data in which a distance between a traveling direction of the utility pole data and a line segment orthogonal on an xy plane is the closest and which the utility pole data is located in the traveling direction, as subsequent utility pole data. Here, the start point is utility pole data (or a utility pole indicated by the utility pole data) in which there are no other utility poles on the opposite side in the own traveling direction in the same group. The end point is utility pole data (or a utility pole indicated by the utility pole data) in which there are no other utility poles on the own traveling direction in the same group.

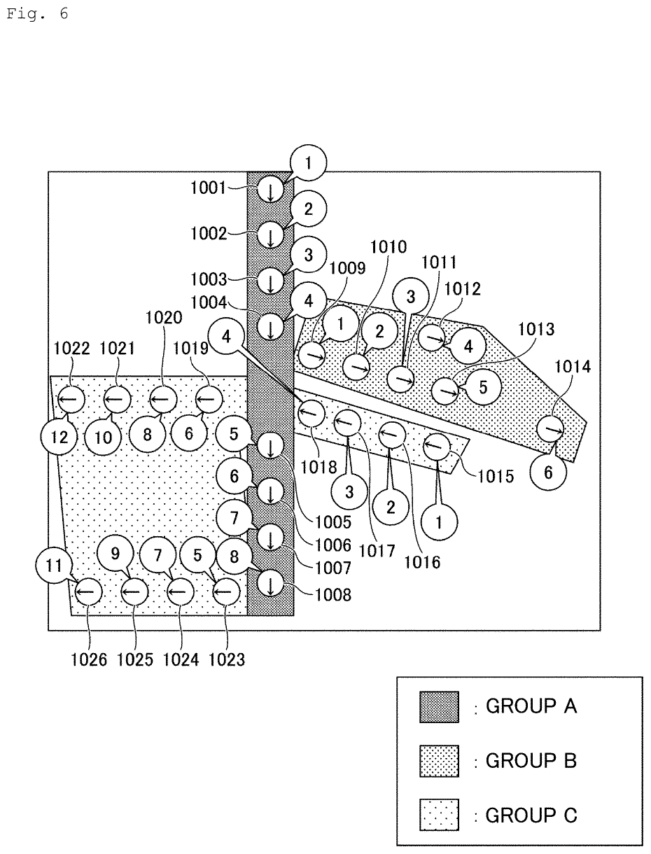

For example, when numbers are sequentially assigned to the utility pole data from the start point to the end point indicating the utility poles 1001 to 1026 illustrated in FIG. 5 for each group, the utility pole data is illustrated in FIG. 6. In the example illustrated in FIG. 6, in Group A, utility pole data indicating the utility pole 1001 is a start point, and the utility pole data indicating the utility pole 1008 is an end point, and numbers 1 to 8 are assigned in order from the utility pole data indicating the utility pole 1001 to the utility pole data indicating the utility pole 1008. In Group B, utility pole data indicating the utility pole 1009 is a start point, and utility pole data indicating the utility pole 1014 is an end point, and numbers of 1 to 6 are assigned in order from the utility pole data indicating the utility pole 1009 to the utility pole data indicating the utility pole 1014. In Group C, utility pole data indicating the utility pole 1015 is a start point, and utility pole data indicating the utility pole 1022 is an end point, numbers of 1 to 4 are assigned in order from the utility pole data indicating the utility pole 1015 to the utility pole data indicating the utility pole 1018. A number 5 is assigned to the utility pole data indicating the utility pole 1023, a number 6 is assigned to the utility pole data indicating the utility pole 1019, a number 7 is assigned to the utility pole data indicating the utility pole 1024, a number 8 is assigned to the utility pole data indicating the utility pole 1020, a number 9 is assigned to the utility pole data indicating the utility pole 1025, a number 10 is assigned to the utility pole data indicating the utility pole 1021, a number of 11 is assigned to the utility pole data indicating the utility pole 1026, and a number of 12 is assigned to the utility pole data indicating the utility pole 1022.

Subsequently, the grouping processing unit 201 selects one group which has not yet been selected among the groups grouped in the foregoing step S101 (step S103). For example, in the example illustrated in FIG. 6, one group which has not yet been selected is selected among groups A to C. Hereinafter, a currently selected group is referred to as a “selected group”. As an example, a case where the selected group is “group C” will be described below.

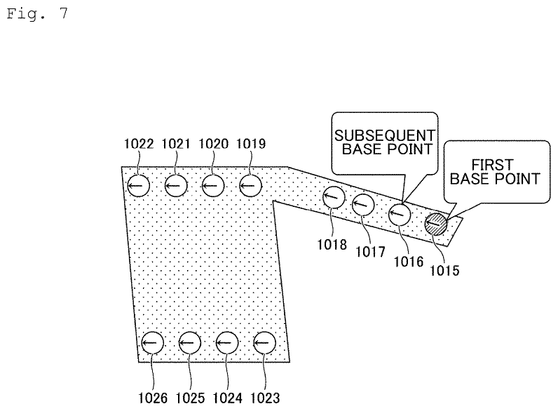

Subsequently, the grouping processing unit 201 sets a start point of the selected group as a base point (step S104). Here, the base point is utility pole data (or a utility pole indicated by the utility pole data) for which it is determined whether another utility pole data belong to the same group as the own group. For example, as illustrated in FIG. 7, since the utility pole data indicating the utility pole 1015 is the start point in Group C, the utility pole data becomes a first base point (a base point set in step S104).

Subsequently, the grouping processing unit 201 determines whether there is the utility pole data that has not yet been used as the base point in the selected group (step S105).

When it is determined in step S105 that there is the utility pole data not yet used as the base point in the selected group (YES in step S105), the grouping processing unit 201 calculates a distance from the base point to the utility pole data that has not yet been used as the base point in the selected group (step S106). For example, when the utility pole data indicating the utility pole 1015 is the base point in the example illustrated in FIG. 7, a distance between the utility pole data and the utility pole data indicating each of the utility poles 1016 to 1026 is calculated. That is, in this case, specifically, the following distances d₁ to d₁₁ are calculated.

The distance d₁ between the utility pole data indicating the utility pole 1015 and the utility pole data indicating the utility pole 1016

The distance d₂ between utility pole data indicating the utility pole 1015 and the utility pole data indicating a utility pole 1017

The distance d₃ between utility pole data indicating the utility pole 1015 and the utility pole data indicating a utility pole 1018

The distance d₄ between utility pole data indicating the utility pole 1015 and the utility pole data indicating a utility pole 1019

The distance d₅ between utility pole data indicating the utility pole 1015 and the utility pole data indicating a utility pole 1020

The distance d₆ between utility pole data indicating the utility pole 1015 and the utility pole data indicating a utility pole 1021

The distance d₇ between utility pole data indicating the utility pole 1015 and the utility pole data indicating a utility pole 1022

The distance d₈ between utility pole data indicating the utility pole 1015 and the utility pole data indicating a utility pole 1023

The distance d₉ between utility pole data indicating the utility pole 1015 and the utility pole data indicating a utility pole 1024

The distance d₁₀ between utility pole data indicating the utility pole 1015 and the utility pole data indicating a utility pole 1025

The distance d₁₁ between utility pole data indicating the utility pole 1015 and the utility pole data indicating a utility pole 1026

Euclidean distances may be calculated as the distances, but the present invention is not limited thereto, and other distances such as Manhattan distances may be calculated. The same applies below.

Subsequently, the grouping processing unit 201 calculates an angle between the direction vector indicating the traveling direction of the start point of the selected group and the vector connecting the utility poles indicated by the utility pole data which has not yet been used as the base point (step S107). For example, when the utility pole data indicating the utility pole 1015 is the base point in the example illustrated in FIG. 7, the utility pole data is also the start point. Therefore, the angle between the direction vector indicating the traveling direction of the utility pole data and the vector connecting the utility pole data and each of the utility poles 1016 to 1026 is calculated. That is, in this case, specifically, each of the following angles φ₁ to φ₁₁ is calculated.

An angle φ₁ between the direction vector and a vector connecting the utility pole 1015 and the utility pole 1016

An angle φ₂ between the direction vector and a vector connecting the utility pole 1015 and the utility pole 1017

An angle φ₃ between the direction vector and a vector connecting the utility pole 1015 and the utility pole 1018

An angle φ₄ between the direction vector and a vector connecting the utility pole 1015 and the utility pole 1019

An angle φ₅ between the direction vector and a vector connecting the utility pole 1015 and the utility pole 1020

An angle φ₆ between the direction vector and a vector connecting the utility pole 1015 and the utility pole 1021

An angle φ₇ between the direction vector and a vector connecting the utility pole 1015 and the utility pole 1022

An angle φ₈ between the direction vector and a vector connecting the utility pole 1015 and the utility pole 1023

An angle φ₉ between the direction vector and a vector connecting the utility pole 1015 and the utility pole 1024

An angle φ₁₀ between the direction vector and a vector connecting the utility pole 1015 and the utility pole 1025

An angle φ₁₁ between the direction vector and a vector connecting the utility pole 1015 and the utility pole 1026

Instead of the angles, cosine values may be calculated. That is, for example, cosφ₁ to cosφ₁₁ may be calculated instead of the angles φ₁ to φ₁₁.

Subsequently, the grouping processing unit 201 determines whether there is the utility pole data in which both the distance and the angle are equal to or less than predetermined thresholds among the utility pole data which has not yet been used as the base point in the selected group (step S108). That is, when the threshold of the distance is th₁ and the threshold of the angle is th₂, the grouping processing unit 201 determines whether there is the utility pole data in which the distance calculated in the foregoing step S106 is equal to or less than th₁ and the angle calculated in the foregoing step S107 is equal to or less than th₂. For example, in the example illustrated in FIG. 7, when the utility pole data indicating the utility pole 1015 is the base point, it is determined whether dᵢ≤th₁ and φᵢ≤th₂ for each i=1, . . . , 11. The threshold th₁ of the distance and the threshold the of the angle are set to appropriate values in advance, but for example, it is conceivable that th₁=0.1 [km] and th₂=45° and the like are set.

When it is determined in step S108 that there is the utility pole data in which both the distance and the angle are equal to or less than the predetermined thresholds (YES in step S108), the grouping processing unit 201 sets the utility pole data as the subsequent base point by assuming that the utility pole data in which a distance to the current base point is the smallest belongs to the same group (step S109). For example, in the example illustrated in FIG. 7, when the utility pole data indicating the utility pole 1015 is the current base point, the subsequent base point is the utility pole data indicating the utility pole 1016, and the utility pole data indicating the utility pole 1015 and the utility pole data indicating the utility pole 1016 are grouped into the same group. This is because it is considered that the utility pole data in which both the distance and the angle are equal to or less than the thresholds is along the same road as that of the utility pole data which is the base point, and the traveling direction during inspection is close.

Accordingly, the current base point and the subsequent base point are grouped into the same group, and step S105 and the subsequent steps are executed again using the subsequent base point as a current base point.

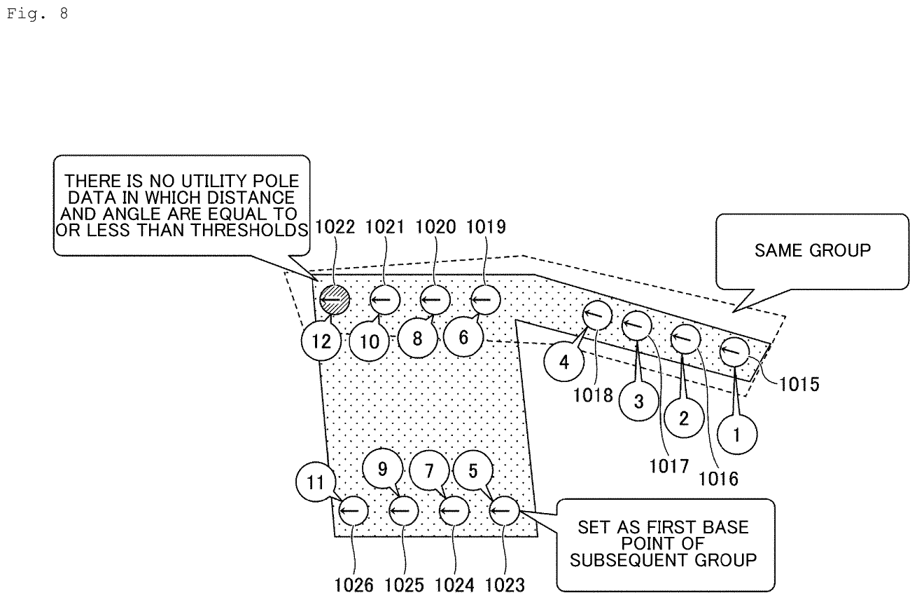

Conversely, when it is not determined in step S108 that there is the utility pole data in which both the distance and the angle are equal to or less than the predetermined thresholds (NO in step S108), the grouping processing unit 201 sets the utility pole data with a minimum number among the utility pole data that has not yet been used as the base point in the selected group as a first base point of the subsequent group (step S110). For example, as illustrated in FIG. 8, it is assumed that the utility pole data indicating the utility poles 1015 to the utility poles 1022 is grouped into the same group, and the utility pole data indicating the utility poles 1015 is the current base point (a base point before the present step is executed). At this time, when there is no utility pole data in which the distance and the angle are equal to or less than the thresholds in the utility pole data which has not yet been used as the base point in the selected group, the utility pole data (the utility pole data indicating the utility pole 1023) with the minimum number among the utility pole data which has not yet been used as the base point is set as the first base point of the subsequent group. Accordingly, step S105 and the subsequent steps are executed again setting the first base point as the current base point of the subsequent group. In the example illustrated in FIG. 8, finally, Group C is divided into two groups including a group in which the utility pole data indicating the utility poles 1015 to 1022 is grouped and a group in which the utility pole data indicating the utility poles 1023 to 1026 is grouped.

When it is not determined in step S105 that there is the utility pole data that has not yet been used as a base point in the selected group (NO in step S105), the grouping processing unit 201 determines whether there is a group that has not yet been selected among the groups grouped in step S101 (step S111).

When it is determined in step S111 that there is the group that has not yet been selected (YES in step S111), the grouping processing unit 201 returns to step S103. Accordingly, step S103 and subsequent steps are executed again until there is no group which has not yet been selected.

Conversely, when it is not determined in step S111 that there is the group that has not yet been selected (NO in step S111), the grouping processing unit 201 ends the grouping processing. Accordingly, each piece of utility pole data can be grouped setting the utility pole data indicating the utility poles inspected at one time in work by an inspection work vehicle (that is, the utility poles for which a traveling direction is close during inspection and which are located along the same road) as the same group.

### <Group Integration Processing>

When the utility pole data is grouped through the grouping processing illustrated in FIG. 4, a group to which only one piece of utility pole data belongs as an element (hereinafter referred to as an isolated group) and a group to which a small number of pieces of utility pole data (for example, about 2 to 4 pieces of utility pole data) belong as elements (hereinafter referred to as a small group) can be obtained. In order to further reduce a usage amount of memory used when generating a cyclic route through reinforced learning, it is preferable to integrate the isolated group or the small group with another group and reduce the number of visiting destinations. Thus, a case where the isolated group or the small group is integrated with another group will be described below.

### <Group Integration Processing (Part 1)>

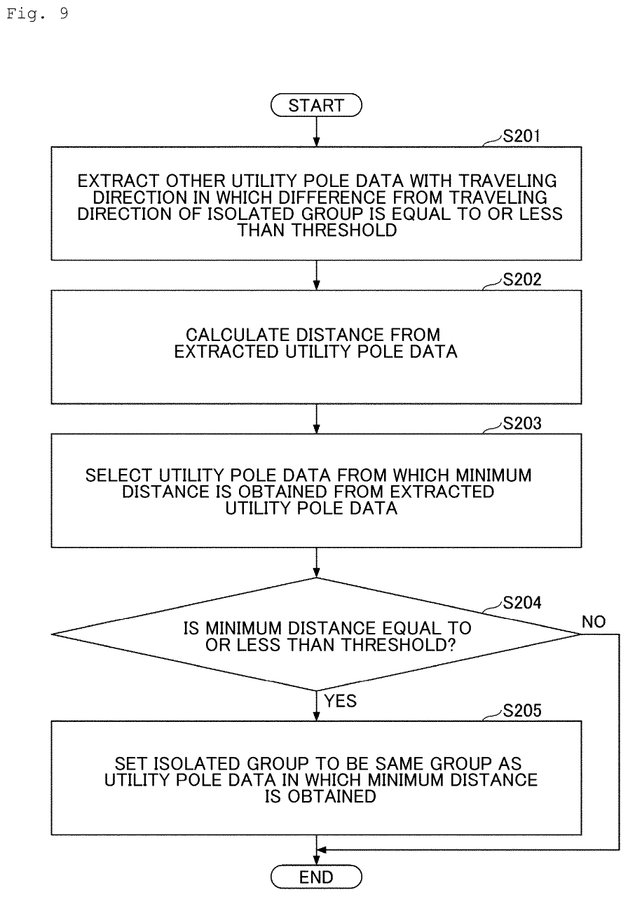

Hereinafter, a group integration processing for integrating an isolated group with another group will be described below with reference to FIG. 9. Hereinafter, a case in which a certain isolated group is integrated with another group will be described.

First, a grouping processing unit 201 extracts other utility pole data having a traveling direction in which an absolute value of a difference from the traveling direction of the utility pole data included in the isolated group is equal to or less than a predetermined threshold from a utility pole data storage unit 301 (step S201). If the threshold is the, for example, it is conceivable that th₃=th₂ or the like is set. Hereinafter, the utility pole data extracted in this step will be referred to as “extracted utility pole data”.

Subsequently, the grouping processing unit 201 calculates distances between the utility pole data included in the isolated group and the extracted utility pole data extracted in step S201 (step S202). It is noticed that, if the number of pieces of extracted utility pole data extracted in step S201 is n₁, in this step, n₁ distances are calculated.

Subsequently, the grouping processing unit 201 selects extracted pole data in which the distance calculated in step S202 is a minimum from the extracted pole data extracted in step S201 (step S203). That is, the grouping processing unit 201 selects the extracted utility pole data from which the minimum distance is obtained in step S202.

Subsequently, the grouping processing unit 201 determines whether the minimum distance is equal to or less than a predetermined threshold (step S204). If the threshold is the, for example, it is conceivable that th₄=th₁ is set.

When it is determined in step S204 that the minimum distance is equal to or less than the threshold (YES in step S204), the grouping processing unit 201 sets the isolated group as the same group as the extracted utility pole data from which the minimum distance is obtained (step S205). Accordingly, the isolated group is integrated into a group including the extracted utility pole data in which the minimum distance is obtained.

Conversely, when it is not determined in step S204 that the minimum distance is equal to or less than the threshold (NO in step S204), the grouping processing unit 201 ends the group integration processing. In this case, the isolated group is left as it is, and the integration with another group is not performed.

### <<Group Integration Processing (Part 2)>>

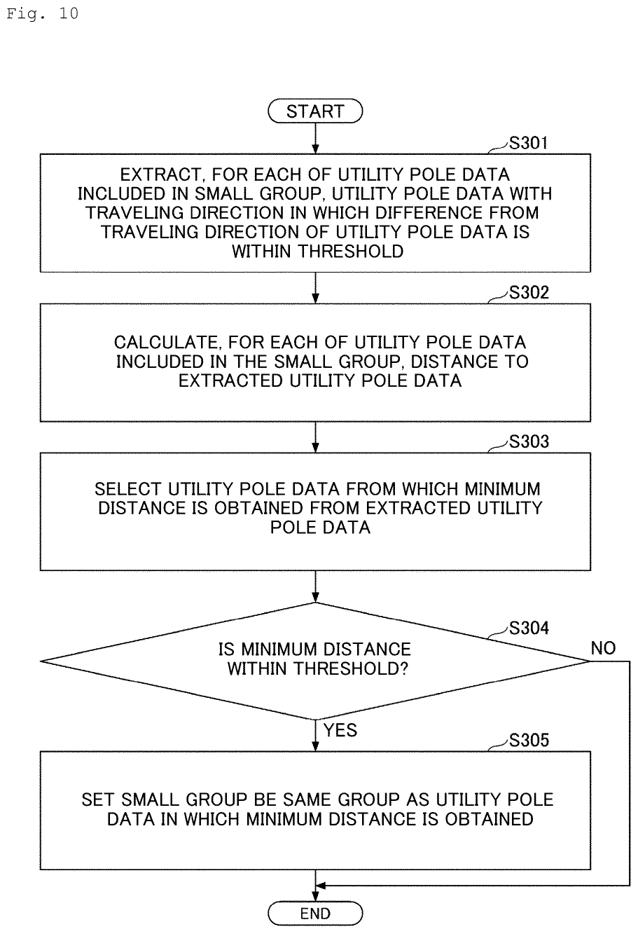

Hereinafter, group integration processing when a small group is integrated with another group will be described with reference to FIG. 10. Hereinafter, a case in which a certain small group is integrated with another group will be described.

First, the grouping processing unit 201 extracts, for each piece of utility pole data included in the small group, another utility pole data with a traveling direction in which an absolute value of a difference from the traveling direction of the utility pole data is equal to or less than a predetermined threshold from the utility pole data storage unit 301 (step S301). As the threshold, the threshold th₃ may be used similarly to step S201 of FIG. 9. Hereinafter, the utility pole data extracted in this step will be referred to as “extracted utility pole data”.

Subsequently, the grouping processing unit 201 calculates a distance between each piece of utility pole data included in the small group and the extracted utility pole data extracted in step S301 (step S302). When the number of pieces of utility pole data included in the small group is n₂ and the number of pieces of extracted utility pole data extracted in step S301 is n₃, it is noticed that in this step, n₂×n₃ distances are calculated.

Subsequently, the grouping processing unit 201 selects the extracted utility pole data from which the minimum distance is obtained in step S302 from the extracted utility pole data extracted in step S301 (step S303).

Subsequently, the grouping processing unit 201 determines whether the minimum distance is equal to or less than a predetermined threshold (step S304). As the threshold, the threshold the may be used similarly to step S303 in FIG. 9.

When it is determined in step S305 that the minimum distance is equal to or less than the threshold (YES in step S304), the grouping processing unit 201 sets the small group as the same group as the extracted utility pole data from which the minimum distance is obtained (step S305). Accordingly, the small group is integrated into the group including the extracted utility pole data in which the minimum distance is obtained.

Conversely, when it is not determined in step S304 that the minimum distance is equal to or less than the threshold (NO in step S304), the grouping processing unit 201 ends the group integration processing. In this case, the small group is left as it is, and integration with another groups is not performed.

### Second Embodiment

Hereinafter, a second embodiment will be described. In the present embodiment, a case where the utility pole data is grouped using road section information included in map data will be described. Here, the road section information is information indicating which point from which point to which point on a road is a road corresponding to one section. A road corresponding to one section (hereinafter referred to as a road section) is a road in a section from an end point (a street corner, a branch point (an intersection, a trifurcated road, or the like) or the like) of the road to another end point. As a typical example, for example, a section between a certain intersection and a next intersection corresponds to a road section.

In the present embodiment, differences from the first embodiment will be mainly described, and descriptions of components similar to those in the first embodiment will be omitted.

### <Functional Configuration Example of Grouping Device 10>

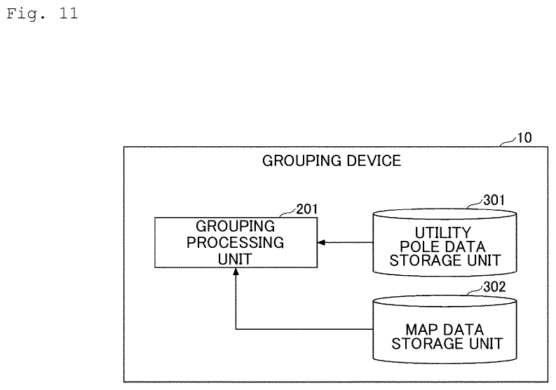

FIG. 11 illustrates a functional configuration example of the grouping device 10 according to the embodiment. As illustrated in FIG. 11, the grouping device 10 according to the present embodiment includes a map data storage unit 302 in addition to components described in the first embodiment. The map data storage unit 302 is realized by, for example, the auxiliary storage device 107 or the like. However, the map data storage unit 302 may be realized by, for example, a storage device such as a database server or the like connected to the grouping device 10 and a communication network.

The grouping processing unit 201 groups the utility pole data indicating the utility poles with the traveling direction during inspection using the road section information included in the map data stored in the map data storage unit 302 as the same group of the utility poles located along the same road inspected in the traveling direction.

The map data storage unit 302 stores the map data including at least the road section information.

In the example illustrated in FIG. 1, the map data is stored in the map data storage unit 302. However, for example, the map data may be provided by an external business provider or the like. In this case, the grouping processing unit 201 may acquire the map data using, for example, a WebAPI disclosed by the business operator or the like.

### <Grouping Processing>

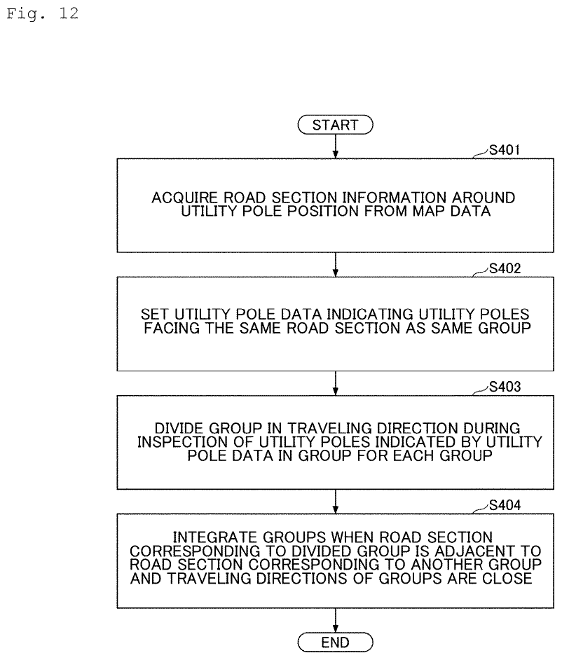

Hereinafter, grouping processing according to the present embodiment will be described with reference to FIG. 12.

First, the grouping processing unit 201 acquires road section information indicating a road sections around a position (utility pole position) of a utility pole indicated by the utility pole data stored in the utility pole data storage unit 301 from the map data (step S401). For example, the grouping processing unit 201 may obtain a maximum value and a minimum value of a utility pole position (longitude) included in the utility pole data and a maximum value and a minimum value of a utility pole position (latitude) stored in the utility pole data storage unit 301, and may acquire road section information indicating a road section within a range including the maximum value and the minimum value of the utility pole position (longitude) and the maximum value and the minimum value of a utility pole position (latitude) from the map data.

Subsequently, the grouping processing unit 201 uses the road section information acquired in step S401 to set utility pole data indicating utility poles facing the same road section (that is, utility pole data indicating utility poles along the same road section) as the same group (step S402). Here, the utility pole data indicating the utility poles facing the same road section is, for example, utility pole data in which a distance to a line segment indicating the road section is less than a predetermined threshold (for example, about several meters to tens of meters).

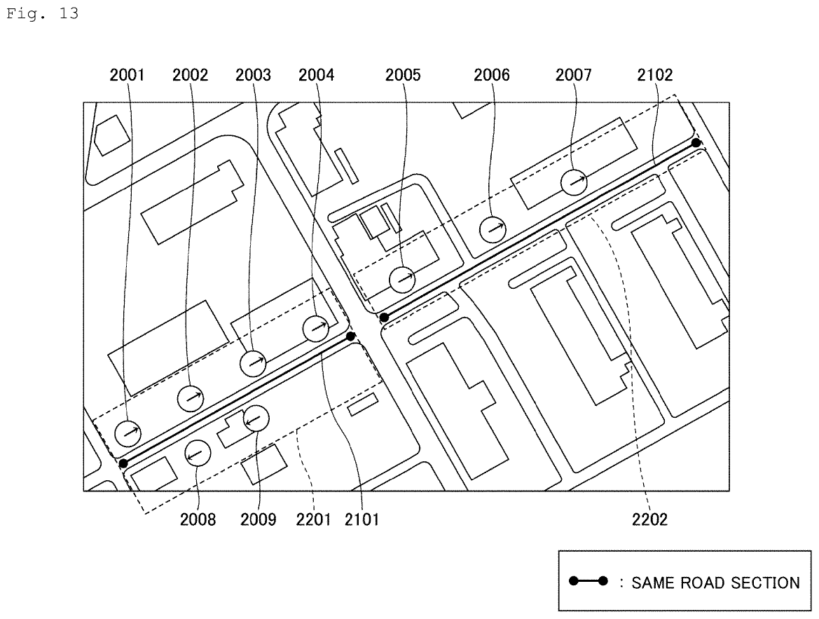

For example, as illustrated in FIG. 13, when there are utility poles 2001 to 2004 and 2008 and 2009 facing a road section 2101, utility pole data indicating these utility poles 2001 to 2004 and 2008 and 2009 is grouped into a group 2201. Similarly, when there are the utility poles 2005 to 2007 facing a road section 2102, the utility poles 2005 to 2007 are grouped into a group 2202.

Subsequently, the grouping processing unit 201 divides the group into groups grouped in step S402 in the traveling direction during inspection of the utility poles indicated by the utility pole data in the group (step S403). For example, an angle between a line segment representing a road section corresponding to the group and the x axis is Φ. At this time, the grouping processing unit 201 obtains an absolute value Δ₁ of a difference between the traveling direction and the angle Φ of the utility pole data in the group and an absolute value Δ₂ of a difference between the traveling direction and an angle Φ+π of the utility pole data, sets the utility pole data as a first group when Δ₁≤A₂, and sets a second group when Δ₁>Δ₂.

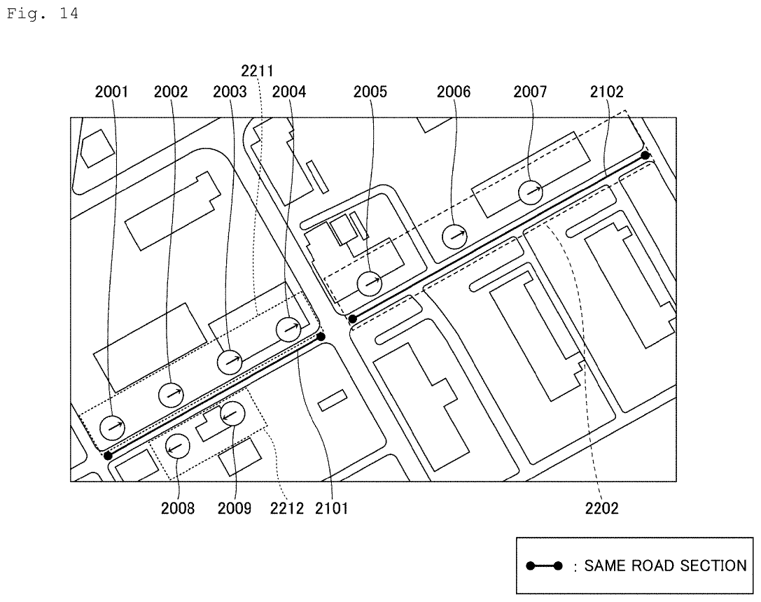

Thus, in the example illustrated in FIG. 13, for example, as illustrated in FIG. 14, the group 2201 is divided into a group 2211 in which utility pole data indicating the utility poles 2001 to 2004 are elements and a group 2212 in which utility pole data indicating the utility poles 2008 and 2009 are elements. The group 2202 becomes the same group before and after the division.

Subsequently, the grouping processing unit 201 integrates the groups when the road sections corresponding to the divided groups are adjacent to the road sections corresponding to the other group and the traveling directions of the groups are close (step S404). Here, two road sections adjacent to each other means that, for example, an end point of one road section is the same as an end point of the other road section. The traveling direction of the group means, for example, an average or the like of the traveling directions of the utility pole data included in the group.

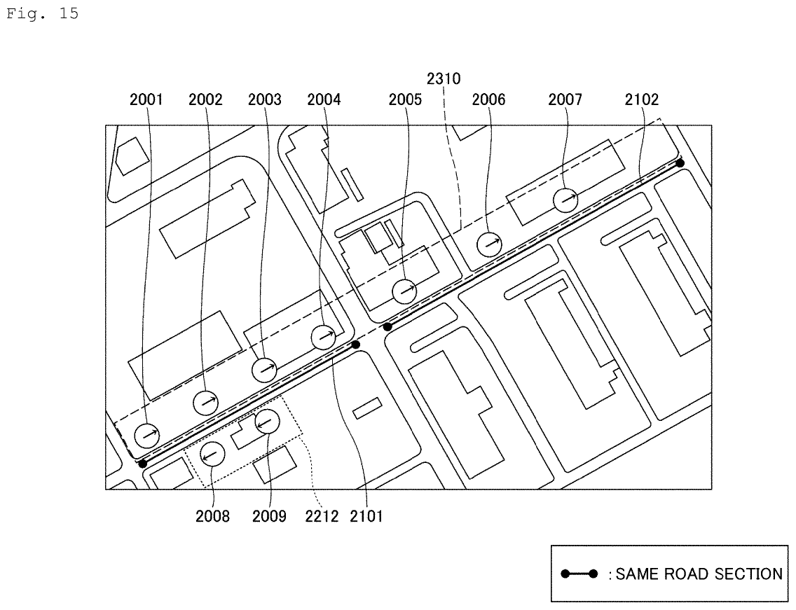

Accordingly, in the example illustrated in FIG. 14, the groups 2211 and 2202 are integrated into the group 2310, for example, as illustrated in FIG. 15. Accordingly, finally, in the example illustrated in FIG. 15, the utility pole data indicating the utility poles 2001 to 2009 are grouped into groups 2310 and 2212.

In step S404, the traveling direction of the group is used. However, instead of the traveling direction of the group, for example, an angle between a line segment indicating a road section corresponding to the group and an x axis may be used. In this case, when the angle between the line segment indicating the road section corresponding to the group and the x axis is close, the groups are integrated.

After the foregoing grouping processing is performed, the group integration processing may be performed as in the first embodiment.

### Conclusion

As described above, the grouping device 10 according to the first embodiment can group the utility pole data of the utility poles inspected at one time in work by an inspection work vehicle as the same group in consideration of the traveling direction of the utility poles during inspection.

The grouping device 10 according to the second embodiment can group each piece of utility pole data using map data including information indicating a road section in consideration of the traveling direction during inspection of the utility poles by setting the utility pole data of the utility poles inspected at one time by an inspection work vehicle as the same group.

Therefore, by using the grouping device 10 according to the first and second embodiments, the number of visiting destinations in generation of a cyclic route in which each group is a visiting destination is reduced. Therefore, memory consumption can be curbed in generation of a cyclic route by reinforced learning and the accurate cyclic route can be obtained.

The case in which the grouping device 10 groups the utility pole data has been described, but the grouping device 10 may further generate a cyclic route in which each group is a destination according to a known reinforced learning method.

The present invention is not limited to the foregoing specifically disclosed embodiments, and various modifications and changes, combinations with known techniques, and the like can be made without departing from the scope of the claims.

### REFERENCE SIGNS LIST

10 Grouping device
101 Input device
102 Display device
103 External I/F
103a Recording medium
104 Communication I/F
105 RAM
106 ROM
107 Auxiliary storage device
108 Processor
109 Bus
201 Grouping processing unit
301 Utility pole data storage unit
302 Map data storage unit

1. A grouping device that comprising:
a processor; and
a memory storing program instructions that cause the processor to group targets on which work is performed at one time into an identical group by an entity performing the work based on work directions of the targets.

2. The grouping device according to claim 1, wherein the program instructions cause the processor to:
group the plurality of targets into a first group by a predetermined grouping method, and
group the first group into one or more second groups based on a distance between the targets included in the first group and the work directions of the targets included in the first group for each of the first group.

3. The grouping device according to claim 2, wherein in the grouping method, the plurality of targets are grouped into the first group in accordance to which range the work directions of the targets belong among a plurality of predetermined ranges.

4. The grouping device according to claim 2, wherein the program instructions cause the processor to:
set the target at a base point in order of performing the work in the first group for each of the first group,
calculate a distance between the base point and the target which has not yet been set at the base point and an angle between a first vector indicating a work direction of the target on which the work is first performed in the first group and a second vector connecting the base point and the target which has not yet been set at the base point, and groups the targets in which the distance and the angle are both within predetermined thresholds and the distance is a minimum into a second group identical to the base point.

5. The grouping device according to claim 1, wherein the program instructions cause the processor to:
group the targets installed in an identical road section into an identical third group based on information indicating road sections of a road on which the targets are installed,
divide the third group into one or more fourth groups based on the working directions of the targets, and
integrate fourth groups that correspond to adjacent road sections and that are close to each other at a predetermined angle based on the work directions of the targets and the information indicating the road sections.

6. The grouping device according to claim 5, wherein the predetermined angle is an average of angles indicating the work directions of the targets included in the fourth group or an angle of the road section corresponding to the fourth group.

7. A grouping method executed by a grouping device that groups targets in work directions when predetermined work is performed, the method comprising:
grouping the targets on which the work is performed at one time into an identical group by an entity performing the work based on the work direction of the targets.

8. A non-transitory computer-readable recording medium having stored therein a program causing a grouping device that groups targets in work directions when predetermined work is performed to group the targets on which the work is performed at one time into an identical group by an entity performing the work based on the work direction of the targets.
